(19) United States
(12) Patent Application Publication
(10) Pub. No.: US 2010/0031316 A1
(43) Pub. Date: Feb. 4, 2010

(54) SYSTEM ACCESS LOG MONITORING AND REPORTING SYSTEM

(75) Inventor: Susumu Taniguchi, Tokyo (JP)

Correspondence Address: Locke Lord Bissell & Liddell LLP;Attn: IP Docketing, Three World Financial Center, New York, NY, 10281-2101, US

(73) Assignee: INTERNATIONAL BUSINESS MACHINES CORPORATION, Armonk, NY (US)

(21) Appl. No.: 12/182,665

(22) Filed: Jul. 30, 2008

(51) Int. Cl. H04L 9/00

(52) U.S. Cl. 726/3

(57) ABSTRACT

A user requests approval from an application server for accessing a program in a managed server. If the access is approved, the application server issues authentication information which includes at least a public key and a private key. The managed server receives command from the user to execute by the program. An original authentication value is computed from the command. The original authentication value is encrypted with the public key. The encrypted original authentication value is stored in association with the command in a log storage. Alteration of the command can be detected by computing a new authentication value from the stored command. The stored encrypted original authentication value is decrypted with the private key to obtain the original authentication value, which is compared with the new authentication value. An alarm is set if the comparison is not satisfied.

### BACKGROUND

In the IT industry today, there is an increasing demand for firmer security measures to enhance internal control, protect personal information, etc. For system logs in particular, many regulations and industry standards require acquisition and daily monitoring of the log as means for ex-post discovery of security failures. However, with an open system few businesses have embarked on daily monitoring of their logs because skill of a certain level is required for analyzing a log to check that there is no problem and there is a heavy workload involved for monitoring a vast amount of the log. The heavy work load is because the work log acquired is merely a chronological listing of commands (jobs) that have been executed. A work for a system is typically a task consisting of a series of commands (jobs) and approval for the work is also made with the same task as a unit.

Thus, to verify the validity of a work by utilizing log monitoring, it is necessary to match the act of approval against a unit of a series of commands (jobs). However, due to lack of a method to extract a unit of a series of commands (jobs), such verification conventionally relies on the guesswork and expedience of a person who conducts monitoring.

Other products are all techniques for collecting log and recording the time, performer, and target of an access, mainly focusing on prevention of fraudulent acts by giving a sense of being watched or using the log as an ex-post evidence of an access. Also, as for log analysis, such techniques show who has done what for each resource of an accessed entity. Although such conventional methods do acquire work log, they still have such problems as follows.

First, it is difficult to check whether a work recorded in log is a legitimate and approved one. Secondly, it is impossible to detect tampering of log or a logging application itself that is performed using a privileged ID. Also, manual operation is required to hamper an unapproved work. Further, since an ID of an OS system administrator is authorized to make every kind of change in a target system, for ex-post verification of the validity of a work performed by a system administrator, it is necessary to prevent tampering of log as well as that of a log output function itself. Although some conventional techniques can prevent log tampering by writing log outside a target system, the system administrator can tamper with the log output function itself.

### SUMMARY

A user requests approval from an application server for accessing a program in a managed server. If the access is approved, the application server issues authentication information which includes at least a public key and a private key. The managed server receives command from the user to execute by the program. An original authentication value is computed from the command. The original authentication value is encrypted with the public key. The encrypted original authentication value is stored value in association with the command in a log storage.

There is detection if the command was altered prior to storage in the log storage through the following steps. The stored command is accessed from the log storage. A new authentication value is computed from the stored command. The stored encrypted original authentication value is accessed. The stored encrypted original authentication value is decrypted with the private key to obtain the original authentication value. The original authentication value is compared with the new authentication value. An alarm is set if the comparison is not satisfied.

### DESCRIPTION OF THE FIGURES

FIG. 1 is a functional block diagram of a computer system that performs system access log monitoring and provides a reporting system.

FIG. 2 is an example flow diagram of an example embodiment for the sequence of steps carried out by the computer system of FIG. 1.

### DISCUSSION OF EXAMPLE EMBODIMENTS OF THE INVENTION

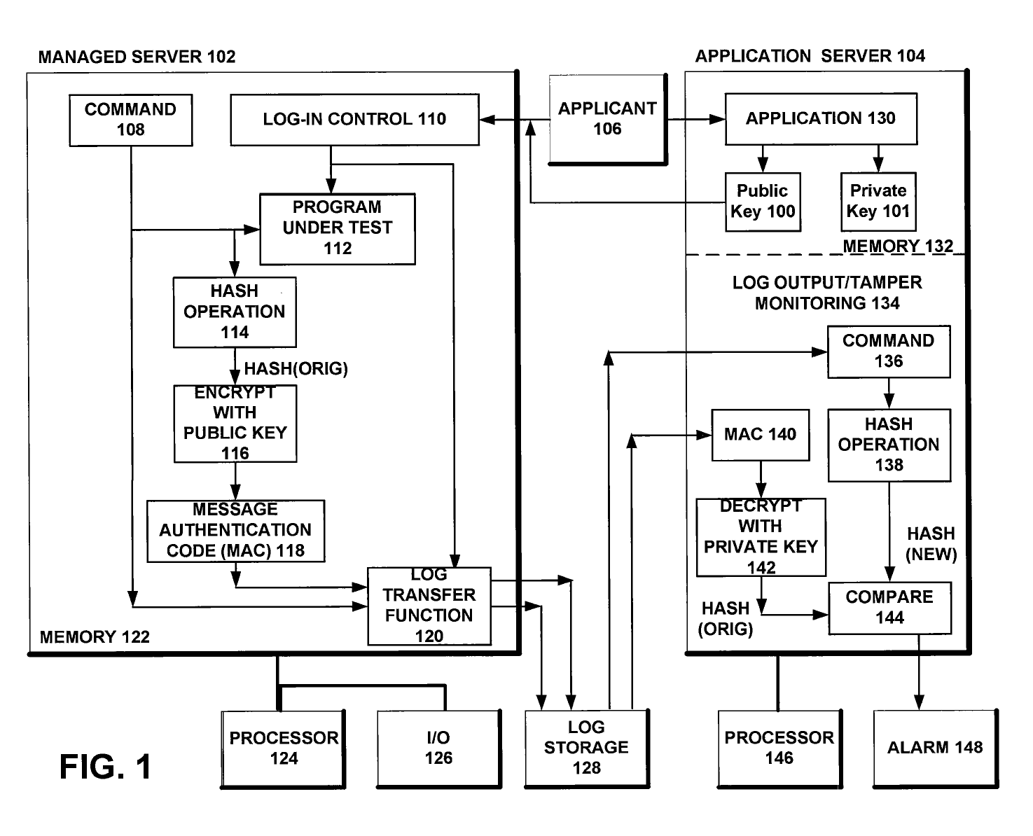

FIG. 1 is a functional block diagram of a computer system that performs system access log monitoring and provides a reporting system. A work applicant 106 applies for approval from the application server 104 in advance of working in the managed server 102. If the application 130 is approved, the application server 104 issues a public log-in authentication key 100 and a private tamper-monitoring authentication key 101 linked with the application 130 as one-time keys, and provides the public log-in authentication key 100 to the applicant 106.

The work applicant 106 enters the public log-in authentication key 100 to log into the managed server 102. The log-in control 110 of the managed server 102 transmits the entered public log-in authentication key 100 to the application server 104 to verify that it is an already approved application 130.

The log-in control 110 of the managed server 102 passes the public log-in authentication key 100 it obtained to the encryption process 116. Then, it permits the applicant 106 to use the execution environment 112. The applicant 106 utilizes the execution environment 112 which is in memory 122 within the managed server 102. The memory 122 and managed server 102 utilize the processor 124 while the applicant 106 utilizes the I/O 126 for interaction with the managed server 102.

The applicant 106 enters commands (jobs) 108 for the scheduled work in the execution environment 112.

The execution environment 112 passes the entered commands (jobs) 108 to the hash operation 114 that produces the original hash. The original hash is then encrypted with the public log-in authentication key 100 in the encryption process 116 and the resulting message authentication code (MAC) 118 is passed as log information to the log transfer function 120.

The log transfer function 120 transfers the MAC 118 with the corresponding command 108 to the log storage 128. The log output/tamper monitoring 134 in the application server 104 calls the command 108 and its corresponding MAC 118 from the log storage 128. The log output/tamper monitoring 134 is located in memory 132 which is in the application server 104 that utilizes the processor 146.

The log output/tamper monitoring function 134 of the application server 104 reads the MAC 118 into the MAC 140 from the log storage 128. The log output/tamper monitoring function 134 then decrypts the MAC 140 with the private tamper-monitoring authentication key 101 in the decryption process 142 to obtain the original hash.

The log output/tamper monitoring function 134 of the application server 104 reads the command 108 into the command 136 from the log storage 128. The log output/tamper monitoring function 134 then performs the hash operation 138 on the command 136 to obtain the new hash.

The log output/tamper monitoring function 134 of the application server 104 then compares the original hash with the new hash in the compare process 144. If the compare process 144 is not satisfied the log output/tamper monitoring 134 in the application server 104 initiates the alarm 148.

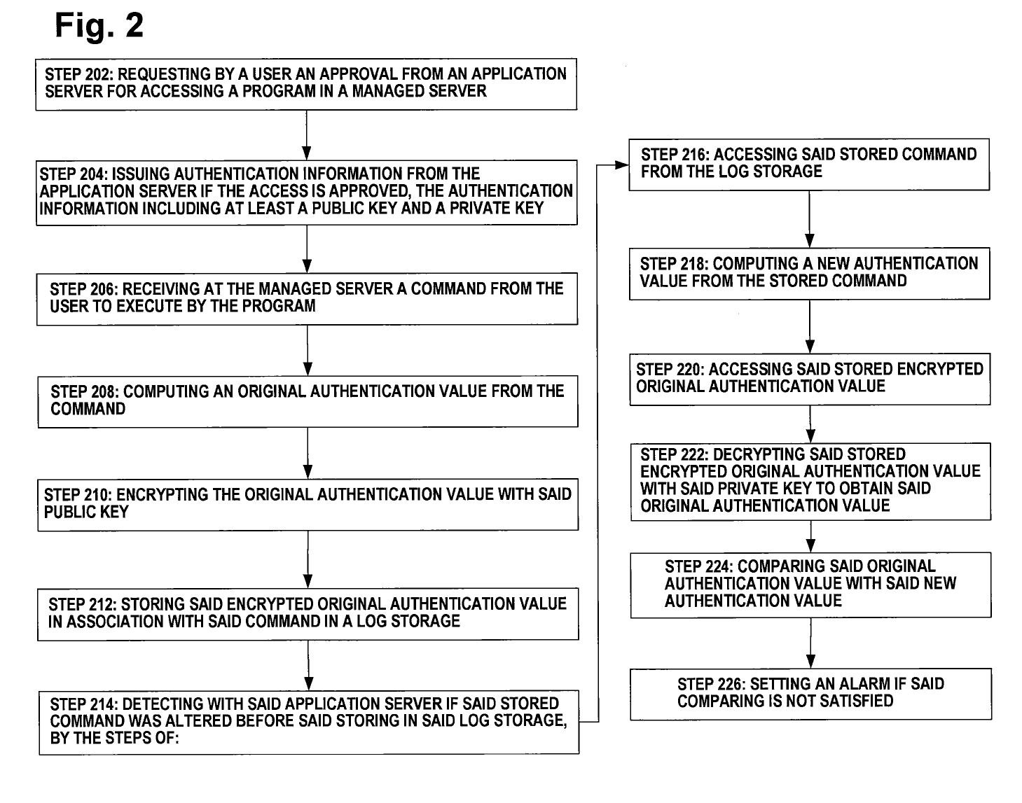

FIG. 2 is an example flow diagram of an example embodiment for the sequence of steps carried out by the computer system of FIG. 1. The steps are as follows:

Step 202: Requesting by a user an approval from an application server for accessing a program in a managed server.

Step 204: Issuing authentication information from the application server if the access is approved, the authentication information including at least a public key and a private key.

Step 206: Receiving at the managed server a command from the user to execute by the program.

Step 208: Computing an original authentication value from the command.

Step 210: Encrypting the original authentication value with said public key.

Step 212: Storing said encrypted original authentication value in association with said command in a log storage.

Step 214: Detecting with said application server if said stored command was altered before said storing in said log storage, by the steps of:

Step 216: Accessing said stored command from the log storage.

Step 218: Computing a new authentication value from the stored command.

Step 220: Accessing said stored encrypted original authentication value.

Step 222: Decrypting said stored encrypted original authentication value with said private key to obtain said original authentication value.

Step 224: Comparing said original authentication value with said new authentication value.

Step 226: Setting an alarm if said comparing is not satisfied.

At least one embodiment of the present invention involves a system that is made up of two servers: an application server 104 responsible for application 130 for access to the system, log output 134, and tamper monitoring 134; and a managed server 102 on which a work 112 is conducted. Once an advance application 130 for a work has been approved, the application server 104 issues public log-in authentication key 100 and a private tamper-monitoring authentication key 101 which are linked with the application 130 and provides the public log-in authentication key 100 to the applicant 106 for use in log-in 110 and internally maintains the private tamper-monitoring authentication key 101 for monitoring of tampering in the compare process 144.

In the managed server 102, functions are deployed: log-in control 110 for consulting the application server 104 about the public log-in authentication key 100 entered at the time of a log-in; an execution environment 112 which links entered commands 108 with the public log-in authentication key 100 to provide them to the log transfer function 120; and the log transfer function 120 which internally maintains the public log-in authentication key 100 received from the log-in control 110 while linking that key with the commands 108 and public log-in authentication key 100 received from the execution environment 112 and transmitting them to the log storage 128.

In the application server 104, a log output/tamper monitoring function 134 is deployed that utilizes the compare process 144 to compare the original hash and the new hash to verify that the functions of the managed server 102 have not been tampered with, and records entered commands 136 being linked with an appropriate application 130 based on the private tamper-monitoring authentication key 101 on a per-application basis.

At least one embodiment of the present invention provides the following advantages. The system generates a public log-in authentication key 100 for log-in when a work application 130 has been approved and an applicant 106 is required to enter the public log-in authentication key 100 at the start of the work, in log-in control 110, so that commands (jobs) 108 during the work are automatically linked with the corresponding application and output in a log 128.

Another advantage is that a private tamper-monitoring authentication key 101 which makes a pair with the public log-in authentication key 100 is maintained within the application server 104 and hidden from the applicant 106. Consequently, even a work by the system administrator can be checked for validity.

Since the system administrator is not aware of the private tamper-monitoring authentication key 101, the log transfer function 120 that has been tampered with cannot transmit a MAC 118 corresponding with the public log-in authentication key 100 that will satisfy the compare process 144. Thus, the log output/tamper monitoring function 134 of the application server 104 can recognize that the transmitted log information is invalid.

By utilizing the public log-in authentication key 100, which is issued at the time of application 130, in log storage 128, the task of associating commands (jobs) 108 with an application 130 is automatically carried out. In addition, by communicating the private tamper-monitoring authentication key 101, which is issued upon each application 130 and hidden from the applicant 106, in the application server 104, validity can be checked in log monitoring even when the applicant 106 is the system administrator for the managed server 102.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments.

Although specific example embodiments have been disclosed, a person skilled in the art will understand that changes can be made to the specific example embodiments without departing from the spirit and scope of the invention.

1. A method, comprising:
requesting by a user an approval of a work application from an application server for accessing a program associated with the work application in a managed server;
issuing authentication information from the application server if the access is approved, the authentication information including at least a public key and a private key;
receiving at the managed server a command from the user to execute by the program;
computing an original authentication value from the command;
encrypting the original authentication value with said public key forming a message authentication code;
storing said encrypted original authentication value in association with said command in a log storage; and
detecting if said stored command was altered before said storing in said log storage, by steps of:
accessing said stored command from the log storage;
computing a new authentication value from the stored command;
accessing said stored encrypted original authentication value;
decrypting said stored encrypted original authentication value with said private key to obtain said original authentication value;
comparing said original authentication value with said new authentication value; and
setting an alarm if said comparing is not satisfied.
